(19) United States
(12) Patent Application Publication
(10) Pub. No.: US 2008/0170647 A1
(43) Pub. Date: Jul. 17, 2008

(54) Device for Noise Reduction

(75) Inventors: Bo Hermansson, Farsta (SE); Mathias Johansson, Bromma (SE)

Correspondence Address: ALBIHNS STOCKHOLM AB, BOX 5581, LINNEGATAN 2, SE-114 85 STOCKHOLM; SWEDENn, STOCKHOLM, omitted

(73) Assignee: ANDREW CORPORATION, Orlando Park, IL (US)

(21) Appl. No.: 11/571,621

(22) PCT Filed: Jul. 5, 2005
(86) PCT No.: PCT/SE2005/001107

§ 371 Date: Nov. 29, 2007

Related U.S. Application Data
(60) Provisional application No. 60/521,828, filed on Jul. 8, 2004.

(30) Foreign Application Priority Data
Jul. 8, 2004 (SE) 0401795-0

(51) Int. Cl. H04B 1/10

(52) U.S. Cl. 375/346; 455/334

(57) ABSTRACT

Device for reducing noise in a radio receiver, which radio receiver comprises a transformer (30) having a reference voltage input (20), a radio signal input at a first transformer side, and a radio signal output at a second transformer side, an A/D converter (40) being connected to said second transformer side, wherein a first bandpass filter (50) is connected between said second transformer side and said A/D converter.

### FIELD OF THE INVENTION

The present invention relates to a radio receiver for a radio base station, in particular for use in third generation (3G) mobile telecommunications systems. More specifically, the invention relates to a device for filtering noise in a radio signal before analog to digital signal conversion.

### BACKGROUND

From the initial analog systems, such as those defined by the standards AMPS (Advanced Mobile Phone System) and NMT (Nordic Mobile Telephone), the cellular telephone industry has had an enormous development in the world in the past decades. In the past years, the development has been almost exclusively focused on standards for digital solutions for cellular radio network systems, such as D-AMPS (e.g., as specified in EIA/TIA-IS-54-B and IS-136) and GSM (Global System for Mobile Communications), generally referred to as the second generation of mobile communications systems.

Currently, the cellular technology is entering the 3^{rd} generation, also denoted 3G. WCDMA (Wideband Code Division Multiple Access) is by far the most widely adopted 3G air-interface technology in the new IMT-2000 frequency bands. Standardized by 3GPP (Third Generation Partnership Project) and ITU (international Telecommunication Union), WCDMA has gained broad acceptance within the wireless communication industry. By 2005, there is expected to be close to 100 WCDMA networks in operation globally.

In WCDMA, user data is spread over a bandwidth of circa 5 MHz. The wide bandwidth supports high user data rates and also provides performance benefits due to frequency diversity. However, the exact data transmission speed that will be available for the system users is not easily predictable. The actual capacity in the mobile networks is affected by a number of factors, such as weather conditions, how many users currently communicate through a common base station, and, most importantly, the distance between the user mobile terminal and the base station antenna. In the terminology for WCDMA, a radio base station is referred to as a Node B.

A radio base station comprises a radio receiver devised to receive radio signals from an antenna coupled to or integrated with the base station. Before processing of the received radio signal, the radio signal is converted from analog to digital. The input radio signal has, in the case of WCDMA, a frequency of about 1920-1980 MHz. However, A/D-converters normally used in a radio receiver have a bandwidth which is considerably smaller, typically less than 700 MHz. Frequency conversion is therefore required before supplying the signal to the A/D converter. For this purpose, a front end circuit is employed between radio receiving circuits and the A/D converter, typically mixing the input signal frequency down to a fixed intermediate frequency in the range of 100-300 MHz. This intermediate frequency is conducted through a transformer for providing a reference voltage to the input ports of the A/D converter. The A/D converter has a sampling frequency which is lower than the intermediate frequency, typically 30-100 MHz.

A prior art solution of a radio receiver circuit is partially and schematically illustrated in FIG. 1, where an incoming radio signal is received from the left. A transformer 30 is provided with a reference voltage at 20. The transformer 30 is connected to the A/D converter 40. In order to eliminate or suppress noise, such as disturbances or interference, from the analog radio signal, a bandpass filter 10 is commonly connected before the transformer. However, it has been discovered that despite the bandpass filter 10, noise reduction is many times insufficient.

### SUMMARY OF THE INVENTION

It is a general object of the invention to provide a radio receiver solution which has improved capabilities for suppressing noise, compared to prior art solutions. According to a first aspect of the present invention, this object is fulfilled by a device for reducing noise in a radio receiver, which radio receiver comprises a transformer having a reference voltage input, a radio signal input at a first transformer side, and a radio signal output at a second transformer side, an AID converter being connected to said second transformer side, wherein a first bandpass filter is connected between said second transformer side and said A/D converter.

In one embodiment, a second bandpass filter is connected to said first transformer side for suppressing unwanted Nyquist zones from a received radio signal before said transformer.

In one embodiment, said first bandpass filter is devised to suppress common mode noise.

In one embodiment, said first bandpass filter is devised to suppress differential mode noise.

In one embodiment, said receiver is devised to convert a frequency of an input radio signal to a fixed intermediate frequency, and said A/D converter has a sampling frequency which is less than half said intermediate frequency, wherein said first bandpass filter has a bandwidth which is less than half said intermediate frequency.

In one embodiment, said second transformer side is connected by two leads to said A/D converter, wherein said first bandpass filter includes a capacitive connection between said two leads.

In one embodiment, said first bandpass filter includes an inductive connection between said two leads.

In one embodiment, said first bandpass filter includes a resistive load on each of said two leads.

In one embodiment, said first bandpass filter includes a capacitive connection from ground to each of said two leads.

### BRIEF DESCRIPTION OF THE DRAWINGS

The features and advantages of the present invention will be more apparent from the following description of the preferred embodiments with reference to the accompanying drawings, on which

FIG. 1 schematically illustrates a prior art solution for noise reduction in a radio receiver;

FIG. 2 illustrates a block diagram of an embodiment comprising a bandpass filter on the transformer output side; and

FIG. 3 illustrates an embodiment of said bandpass filter.

### DETAILED DESCRIPTION OF PREFERRED EMBODIMENTS

FIG. 2 illustrates schematically an embodiment of a device for noise reduction in a radio receiver. A received radio signal is input from the left in the drawing to a first transformer side of a transformer 30. A second transformer side outputs a voltage transformed radio signal to an A/D converter 40. Transformer 30 is used for providing a reference voltage for the subsequent A/D converter 40, which reference voltage is supplied at 20 from a voltage source (not shown).

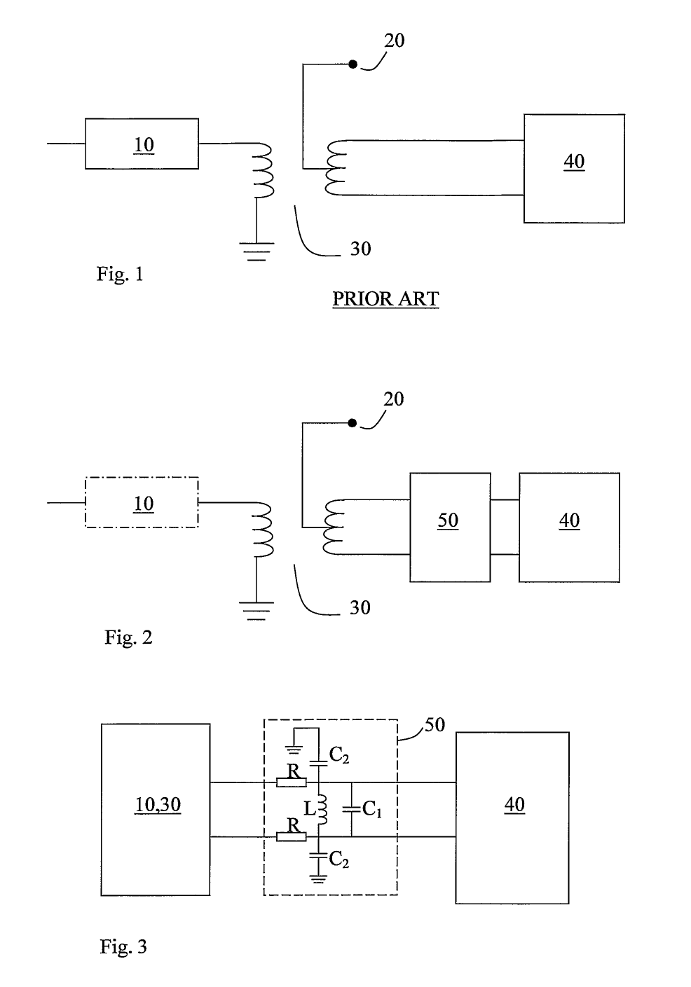

According to the invention, a first bandpass filter 50 is placed between the second, output, side of the transformer 30 and A/D converter 40. Preferably, filter 50 has a bandwidth which is less than half the sampling frequency of A/D converter 40, which is about 30-100 MHz in one embodiment, since the bandwidth of the desired radio signal to convert in A/D converter 40 is typically less than 10 MHz. It has been found that by placing the bandpass filter 50 on the output side of transformer, immediately before the A/D converter, noise reduction is improved. The reason for this is believed to be that with the prior art solution as illustrated in FIG. 1, the transformer 30 and the leads to and from the transformer may still pick up both capacitively and inductively coupled disturbances on unwanted frequencies in other Nyquist zones. Furthermore, these disturbances may be of both common mode and differential mode character. Therefore, by placing bandpass filter 50 after transformer 30, disturbances picked up in the transformer may be reduced, and by placing bandpass filter 50 as close as possible to A/D converter 40, an optimized noise reduction is obtained by minimizing the leads which may pick up noise after the filter.

In one embodiment, a second bandpass filter 10 may still be used in front of the transformer 30, this optional feature being indicated by the dash-dotted contour of bandpass filter 10 in FIG. 2.

FIG. 3 schematically illustrates a design for the bandpass filter 50, placed between transformer 30 and A/D converter 40, optionally with a second bandpass filter 10 before the transformer. Bandpass filter 50 receives two signal leads from transformer 30. Preferably, an inductive connection L, and a capacitive connection C₁, is provided between the two leads. Furthermore, both leads are preferably connected to ground over a capacitive connection C₂. Filter 50 may also include a resistive component R on each lead.

Typical component values and value ranges for an embodiment of the invention are presented in the table below.

| Component | Impedance range | Typical impedance |
|---|---|---|
| C₁ | 5-7 pF | 6 pF |
| C₂ | 35-45 pF | 40 pF |
| L | 10-30 nH | 22 nH |
| R | 45-55 ohm | 51 ohm |

The present invention provides an improved solution for reducing noise in a radio receiver, and is typically usable in a base station in a WCDMA network, but is not limited to this field. The invention is limited only by the appended claims.

1. Device for reducing noise in a radio receiver, which radio receiver comprises a transformer having a reference voltage input, a radio signal input at a first transformer side, and a radio signal output at a second transformer side, an A/D converter being connected to said second transformer side, wherein a first bandpass filter is connected between said second transformer side and said A/D converter.

2. The device as recited in claim 1, wherein a second bandpass filter is connected to said first transformer side for suppressing unwanted Nyquist zones from a received radio signal before said transformer.

3. The device as recited in claim 1, wherein said first bandpass filter is devised to suppress common mode noise.

4. The device as recited in claim 1, wherein said first bandpass filter is devised to suppress differential mode noise.

5. The device as recited in any claim 1, wherein said receiver is devised to convert a frequency of an input radio signal to a fixed intermediate frequency, and said A/D converter has a sampling frequency which is less than half said intermediate frequency, wherein said first bandpass filter has a bandwidth which is less than half said intermediate frequency.

6. The device as recited in claim 1, wherein said second transformer side is connected by two leads to said A/D converter, wherein said first bandpass filter includes a capacitive connection between said two leads.

7. The device as recited in claim 6, wherein said first bandpass filter includes an inductive connection between said two leads.

8. The device as recited in claim 6, wherein said first bandpass filter includes a resistive load on each of said two leads.

9. The device as recited in claims 6, wherein said first bandpass filter includes a capacitive connection from ground to each of said two leads.
